(19) United States
(12) Patent Application Publication
(10) Pub. No.: US 2018/0280748 A1
(43) Pub. Date: Oct. 4, 2018

(54) TRAINING SYSTEM

(71) Applicant: REAL TRAINING AS, Sande i Vestfold (NO)

(72) Inventors: Arve AASMUNDSETH, Sande (NO); Rickard EDÉN, Olofstorp (SE)

(73) Assignee: REAL TRAINING AS, Sande i Vestfold (NO)

(21) Appl. No.: 15/564,642

(22) PCT Filed: Jul. 5, 2017
(86) PCT No.: PCT/NO2017/050179

§ 371 Date: Oct. 5, 2017

(30) Foreign Application Priority Data
Jul. 7, 2016 (NO) 20161132

(51) Int. Cl. A62C 99/00

(52) U.S. Cl. CPC A62C 99/0081

(57) ABSTRACT

A system for training in fire fighting is provided. A system includes a controller for simulating a fire, a head mounted system including a display and a head mounted tracking system. The display shows the fire simulated by the controller. A fire extinguisher system includes a casing, a nozzle assembly, and a hose connecting the casing with the nozzle assembly. The nozzle assembly further includes a nozzle tracking pattern.

### BACKGROUND OF THE INVENTION

### Field of the Invention

The invention relates to training in general and more specifically a system for training in fire fighting.

### Background Art

It is well known that training for fire fighting is difficult to undertake in a realistic manner without incurring undue dangers. The use of open fire can be problematic and there is also the problem with smoke inhalation and the cost and use of fire extinguishers. Also todays training represent a negative climate change end environment impact through emissions of CO2 and extinguishing agent.

Several training systems are already known.
WO2011015562 discloses a method for training the use of fire-fighting equipment, comprising: obtaining input on the movement of a user through a simulated structure from at least one sensor; obtaining input on the use of a simulated fire repressing device from a remote control device; calculating the development of a simulated fire in the simulated structure taking the structure and the input on the use of said simulated fire repressing device into account; generating a video signal reflecting an instantaneous view of a user of a simulated fire in a simulated structure taking the calculated development of the fire and the input on the movement of the user through said structure into account; and sending said generated video signal to a device capable of reproducing said video signal on at least one screen.
The problem is that a scene is projected onto a screen and this limits the movement and realism of the training.
U.S. Pat. No. 6,500,008 discloses a method and apparatus for an augmented reality-based firefighter training system. The system includes hardware for motion tracking, display, and vari-nozzle instrumentation. System software includes a real-time fire model, a layered smoke obscuration model, simulation of an extinguishing agent, and an interface to a zone fire model.
The problem is that this solution requires two different tracking stations (6DOF), one for HMD one for extinguisher.
U.S. Pat. No. 6,129,552 discloses a teaching installation for learning and practicing the use of fire-fighting equipment. Also this is a 2D system so material from the extinguisher will appear on the screen, up to several meters from the user. Thus it lacks the immersion that a HMD based system delivers. The IR system described is of a primitive single point variant that will only detect where the user is aiming at the screen. It has no way of detecting where the user is located.

### SUMMARY OF THE INVENTION

### Problems to be Solved by the Invention

Therefore, a main objective of the present invention is to provide a safe and realistic system for training in firefighting.

### Means for Solving the Problems

The objective is achieved according to the invention by a system as defined in the preamble of claim 1, having the features of the characterising portion of claim 1.

A number of non-exhaustive embodiments, variants or alternatives of the invention are defined by the dependent claims.

The present invention attains the above-described objective by a virtual reality (VR) system comprising a head mounted display provided with a first tracker, a fire extinguisher comprising a nozzle provided with a second tracker, camera systems to determine the position of the first and second tracker, and a system that models and displays a fire, presenting this as a VR image in the head mounted display.

### Effects of the Invention

The technical difference over traditional other trainings systems is that the user is presented with an immersive virtual reality that allows for greater freedom of movement and that the user can interact with the fire from all angles since the tracker can determine where the fire extinguisher is pointed at, using the force applied to the handle and model the rate of discharge of the extinguisher, how it impacts the fire and bring this into the model of fire development to present the user with a realistic scenario where the extinguisher impacts the fire realistically.

This provides in turn further advantageous effects:
training can take place without use of real fires, which can present hazards in itself, and without the use of fire extinguishing material, which could be rather messy,
training is environmentally friendly as there is neither combustion nor emission of fuel and extinguishing chemicals or agents,
training does not involve real dangers regarding heat and chemicals and can therefore be safely conducted indoors and thus also be independent of weather,
training scenario is experienced through the HMD which means that night time scenarios can be performed during daytime and vice versa and thus be independent of real time,
training can be more realistic, involving more complex scenarios with varying scenarios, chemicals, high voltages, obstacles and more,
display of a fire in development can be shown in full without the restrictions of real life hazards or limitations on screen size as in prior art, and
training is more compact and portable compared to real life fire baths or large screens.

### BRIEF DESCRIPTION OF THE DRAWINGS

The above and further features of the invention are set forth with particularity in the appended claims and together with advantages thereof will become clearer from consideration of the following detailed description of an exemplary embodiment of the invention given with reference to the accompanying drawings.

The invention will be further described below in connection with exemplary embodiments which are schematically shown in the drawings, wherein:

FIG. 1 shows an assembled setup for a training session

FIG. 2 shows a connection diagram of the embodiment disclosed in FIG. 1

### DESCRIPTION OF THE REFERENCE SIGNS

The following reference numbers and signs refer to the drawings:

| | |
|---|---|
| 100 | Training system |
| 102 | Scene |
| 104 | Computer |
| 200 | Virtual reality (VR) equipment used by the trainee |
| 220 | Trainee, user to be trained |
| 230 | Head mounted display (HMD) system |
| 232 | Display |
| 234 | HMD tracking pattern, first tracking pattern |
| 240 | Fire extinguisher system, handheld unit |
| 242 | Casing |
| 243 | Casing tracking pattern, second tracking pattern |
| 244 | Handle |
| 246 | Hose |
| 250 | Nozzle assembly |
| 252 | Nozzle handle |
| 254 | Nozzle tracking pattern, third tracking pattern |
| 260 | Casing components |
| 261 | CPU |
| 262 | Power source |
| 263 | Safety pin pulled sensor |
| 264 | Trigger pressed sensor |
| 265 | 9 DOF sensor |
| 266 | Vibrator, haptic feedback unit |
| 267 | Wireless unit |
| 300 | Tracking unit |
| 302 | Stand |
| 304 | First camera for HMD tracking |
| 306 | Second camera for nozzle tracking |

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

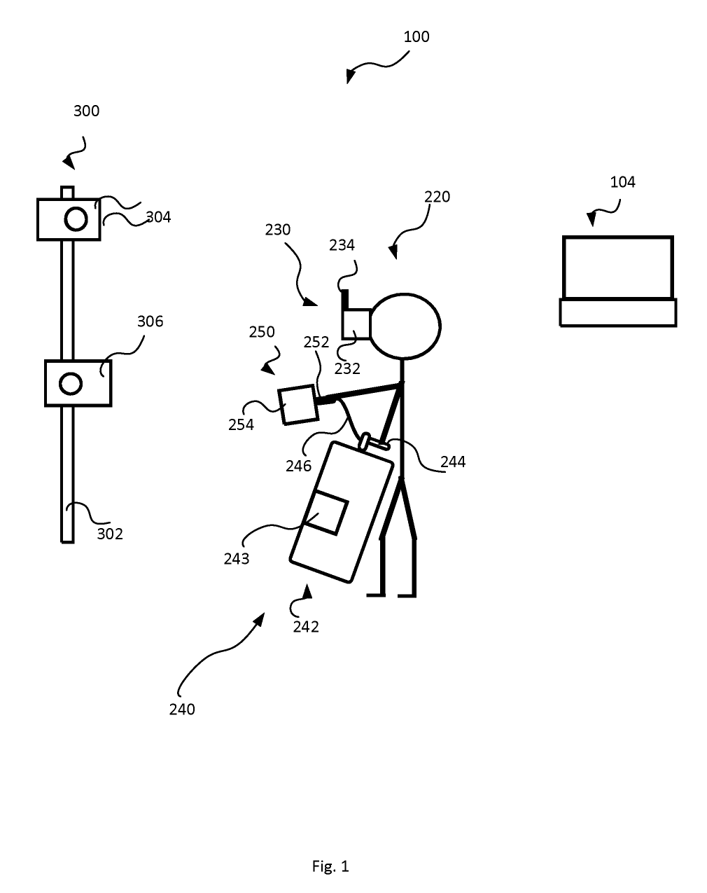

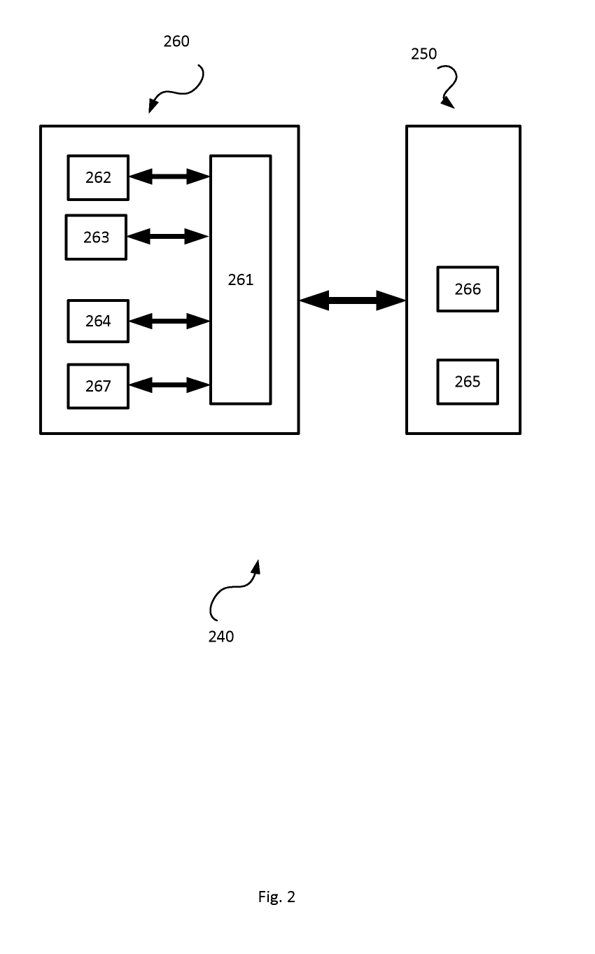

The invention will be further described in connection with exemplary embodiments which are schematically shown in the drawings, wherein FIG. 1 shows an assembled setup for a training session and FIG. 2 shows a connection diagram of the embodiment disclosed in FIG. 1.

Principles Forming the Basis of the Invention

Virtual Reality

By virtual reality, VR, it is intended primarily a system wherein a head mounted display, HMD, provides the entire visual input to the user. A tracking system provides a natural relationship between the movement of the user and the scene shown in the HMD.

Central in the invention is the realisation that the user can carry and use an instrumented fire extinguisher system 240 as a hand held unit, wherein the casing 242, the handle 244, the hose 246 and the nozzle assembly 250 with the nozzle handle all feel natural to the user while in reality it is instrumented to appear to handle and operate realistically in the virtual reality. This is achieved by providing the nozzle assembly with a nozzle tracking pattern 254, allowing the VR system to track the position and orientation of the nozzle in space.

Also important in the invention is the use of a mathematical model for development of a fire. This comprises physical parameters such as temperature, visual parameters such as smoke development, growth of fire when unchecked and extinguishing, in parts or in full, when using a fire extinguisher.

The mathematical model is used to provide visual feedback to the user. Knowing the position and orientation of the nozzle lets the system determine if the extinguishing is effective and to what extent it is effective. The fire model is updated and new visual feedback is presented to the user on the HMD.

### BEST MODES OF CARRYING OUT THE INVENTION

The embodiment of the apparatus 100 according to the invention shown in FIG. 1 shows an assembled setup for a training session. The training system 100 comprises virtual reality (VR) equipment 200 used by the trainee 220 wearing a head mounted display (HMD) system. The HMD in turn comprises a display 232 and a HMD tracking pattern 234, the pattern enables the system to know the position and orientation of the user and thus determine what to present on the display 232.

The user carries a fire extinguisher system 240, a handheld unit, comprising a casing 242, a handle 244, and a hose 246. To a large extent these seem and also feel similar to live equipment. The casing 242 is provided with a casing tracker pattern 243. The hose 246 connects the casing with a nozzle assembly 250, wherein the nozzle assembly comprises a nozzle handle for holding, positioning and orienting the nozzle, and a nozzle tracking pattern 254 to determine the actual position and orientation of the nozzle.

The casing tracking device 243 can be a wedge like structure having two faces with patterns where each face has a pattern that allows a camera to recognise the faces and thus determine the position of the tracking pattern in the camera view and also determine the orientation of the casing tracking pattern.

The nozzle tracking device typically is a structure with several patterns in different directions, where each face has a pattern that allows a camera to recognise the faces and thus determine the position and orientation of the tracking pattern in view.

By determining the size of the tracking patterns viewed by the camera one can determine the distance from the camera and thus locate it in 3D. By determining which patterns are visible and the rotation of the patterns with respect to the camera one can also determine the orientation of the tracking patterns.

The training system defines a scene 102 for the user to train within. The scene also comprises at least one tracking unit. Each tracking 300 unit comprises a stand 302 on which there are mounted a first camera for HMD tracking 304 and a second camera for casing and nozzle tracking. While a single tracking unit can be used to determine positions and orientations it has been found that using two tracking units improves determination and also avoids localisation problems that occur when the user is facing away from the tracking unit and obstructing the camera view with his body.

Computer vision is fairly noisy and inexact due to the optical nature of the images. Light, lenses and other factors introduce errors in the measurement. To mitigate this, Kalman filters are used. To increase the accuracy of the nozzle orientation (which is most important) a 9 DOF sensor is been placed in the nozzle. The data from this (accelerometer/gyro/magnetometer) is fed back to the application wirelessly. This is then combined in the Kalman filter. The nozzle and the extinguisher have preferably one dedicated filter each. Each frame, each detected patterns' location and orientation is fed into the filter and the output is used to estimate the position and orientation of the nozzle and extinguisher.

FIG. 2 shows a connection diagram of the embodiment disclosed in FIG. 1.

The casing components 260 comprise a CPU or processing unit 261 powered by a power source 262. The CPU is connected to sensors such as a pin pulled sensor 263 that notifies the system that the user has pulled the pin in preparation of starting the extinguishing, a trigger pressed sensor 264 that notifies the system that the user has pressed the trigger and also what extinguisher discharge rate should be, and a 9 DOF sensor 265 that improves orientation data for the nozzle. The CPU is also connected to a vibrator 266 that provides tactile feedback that the extinguisher is being discharged. The CPU communicates to a central computer 104 using a wireless unit 267.

The HMD 230 is typically connected with wires in order to provide sufficient bandwidth for the display. A wireless system can be used if sufficiently fast and with a low latency in order not to impair realism and image update rate.

The stationary system comprises a computer 104 connected to the at least one tracking unit 300. Advantageously the computer is provided with a printer for issuing certificates for each user that passes the test at the end of the training.

In preparation of a training session the components are connected together and the stands are positioned in the scene. The stands, if there are more than one can either be placed using measured up positions or determine mutual positions using patterns on each stand. The stands are positioned so to define a scene, the area where the user trains and is seen by the tracking system. Preferably the stands are provided with light sources to show with light where the operating areas are.

In use the user puts on the HMD equipment. The simulation of a scenario can be started by an operator or started by the user pulling out a pin from the extinguisher. The fire model starts calculating the development of a fire and the fire is presented to the user in the display of the HMD. The tracking system also determines the position of the casing and the nozzle and these parts are visible in the HMD. Typically the user moves towards the fire, aims the nozzle and presses the switch to start discharging the extinguisher. The system determines where the extinguisher is discharged and adjusts the fire model accordingly.

### Alternative Embodiments

A number of variations on the above can be envisaged. For instance the HMD can be provided with a headset, earplugs or similar means to enable the user to hear the sounds of the fire.

Full body tracking can be achieved using the same optical tracking system as described above and extend it to track the full body of the user. This (and especially hand tracking) enables the simulation to extend beyond simply using the fire extinguisher. The user can now effect the environment by moving inflammable objects out of the fires' way or sealing off the fire. The process would comprise at least one stereo camera. Open source library OpenNI can be used to extract skeleton data which is then filtered and fed into the application to drive a human-like model.

Enabling physics in the application will then allow the user to move and interact with certain objects in the scene.

Augmented reality can also be used instead of purely VR. By using camera's mounted on the VR-helmet the fire can be placed in a real environment (by using the same system as today), or certain functions can be performed by the user outside of the VR environment. For example, the user can reach down to pick up the fire extinguisher in the AR world and when pulling out the safety pin, a sensor sends the signal to start the VR-simulation. This would provide a seamless transition between different training exercises and allow direct interaction with real world objects without removing the HMD.

Heat is an important aspect of real fires. To enhance the immersion of the simulation, IR heating elements can be used. These can either be built into an HMD or placed in the room where the fire would be. Based on data from the simulation, the generated heat could be increased or decreased so that the user feels a heat sensation as they come near the fire.

The immersion can be increased by using existing smoke pellets. This will increase the sense of being in a real environment.

Force feedback can be extended in many ways. By mounting a powerful gyroscope in the handheld unit, haptic feedback can be increased from mere vibrations to an actual counter-force as the material is released from the unit.

While the nozzle tracking pattern in this example is a box like structure there are many other alternatives. One alternative is to use a wedge like structure as for the casing tracker pattern 243. Two rectangular or square patterns are preferably joined along one edge, pointing away from the user. Optionally this can be complemented by two triangular patterns, forming a wedge like box.

A printer for issuing certificates for each user that passes the test at the end of the training is not absolutely required for the invention to operate. In an alternative embodiment the certificates are provided on a server or sent out by email. Preferably a signature or a digital signature is attached.

Multiple users training would be useful since large fires require teamwork. By connecting several training units to the same server, Real Training's system can be used by a group of people collaborating to extinguish a fire in the same simulated environment. This will allow users to take on different roles in the scenario, where one could, for example, act as group leader for the others. This can take one of a few different shapes. The simplest one is having one computer/server where many HMD's and controllers are tracked in the same application. This would minimize hardware requirements. It may introduce situations where users get tangled up. A more advanced solution is to have a central server. Multiple clients then connect over an UDP connection and user data is streamed to and from the clients. The infrastructure would work similarly to how multiplayer games work. This means it is possible to train teams that are geographically separated without the need for gathering all members for training.

Non extinguishing scenarios are known in the real world. The training system can be used for other fire training purposes than pure fire extinguishing. For example, a scenario could be a larger area where a user is placed to assess the situation and call for appropriate actions to be taken. They would have to take decisions (from a ground level) about evacuation, where to place extinguishing teams and what services to call for

### INDUSTRIAL APPLICABILITY

The invention according to the application finds use in training.

1. A system for training fire fighting, the system comprising:
a controller for simulating a fire;
a head mounted system comprising a display and a head mounted system tracking system, wherein the display shows the fire simulated by the controller; and
a fire extinguisher system comprising a casing, a nozzle assembly, and a hose connecting the casing with the nozzle assembly,
wherein the nozzle assembly further comprises a nozzle tracking pattern.

2. The system according to claim 1, wherein the nozzle assembly further comprises a plurality of nozzle tracking pattern to further improve precision of detected position and orientation.

3. The system according to claim 1, wherein the nozzle assembly further comprises a 9 DOF sensor to further improve precision of detected position and orientation.

4. The system according to claim 1, wherein the nozzle assembly further comprises a haptic feedback unit to simulate material flowing through nozzle.

5. The system according to claim 1, wherein the fire extinguisher system further comprises a pin pulled sensor.

6. The system according to claim 1, wherein the system further comprises a first stand for attaching tracking cameras.

7. The system according to claim 6, wherein the first stand further comprises light sources for showing where training area is defined.

8. The system according to claim 6, wherein the system further comprises a second stand, wherein at least one of the first and second stand further comprises patterns to determine the position with respect to each other.
